(19) United States
(12) Patent Application Publication
(10) Pub. No.: US 2020/0167875 A1
(43) Pub. Date: May 28, 2020

(54) METHOD FOR TRANSMITTING A PARTICIPATION PROFILE, CONTROL METHOD AND ASSOCIATED DEVICES

(71) Applicant: COMMISSARIAT À l'ÉNERGIE ATOMIQUE ET AUX ÉNERGIES ALTERNATIVES, PARIS (FR)

(72) Inventor: Duy Long HA, GRENOBLE (FR)

(21) Appl. No.: 16/690,253

(22) Filed: Nov. 21, 2019

(30) Foreign Application Priority Data
Nov. 23, 2018 (FR) 1871779

(51) Int. Cl. G06Q 50/06; G06Q 10/06

(52) U.S. Cl. CPC G06Q 50/06; G06Q 10/06315

(57) ABSTRACT

A method for transmitting a participation profile for a generation period, by an energy management system to a controller, the period being divided into a first plurality of time periods, the participation profile including information concerning changes of consumption of the management system for each time period of the first plurality of time periods, the method including receiving, by the management system, a proposed penalty profile issued by the controller, where the generation period is divided into a second plurality of time periods, and where the penalty profile includes a penalty coefficient associated with the energy consumption for each time period of the second plurality of time periods; optimizing, by the management system, the energy consumption, depending on the proposed penalty profile; determining, by the management system, a participation profile depending on the result of the optimisation step; and transmitting, by the management system, the participation profile to the controller.

### CROSS-REFERENCE TO RELATED APPLICATIONS

This application claims priority to French Patent Application No. 1871779, filed Nov. 23, 2018, the entire content of which is incorporated herein by reference in its entirety.

### FIELD

The present invention relates to methods for controlling a set of consumers in a local electrical grid, who share a local energy source. The present invention concerns more specifically a method for transmitting a participation profile and a method for distributing local energy generation. It also concerns the associated devices.

### BACKGROUND

In a prosumer pool (i.e. a set of producer-consumers) or a set of homes facilitating collective consumption of one or more local energy sources PL, as illustrated in FIG. 1, consumption between the various consumers (or homes) present in the network must be coordinated. To do so, each consumer has a management system SY, which is responsible for managing energy for the consumer. The pool therefore includes a plurality of management systems SY connected to a local electrical grid. As mentioned above, the pool also includes at least one local energy source PL (for example a photovoltaic power station, or solar panels distributed between different homes). The pool is also connected to an electrical network so as to complete local generation by a transformer TR. Finally, a controller CO ensures that the energy consumption of management systems SY is distributed so as to facilitate local energy consumption. To accomplish this, with the state of the art of existing techniques, each management system SY transmits to controller CO a consumption forecast for a given period, called the generation period. Although this manner of proceeding enables the energy resource to be managed optimally, this management is accomplished to the detriment of the consumers' private lives, since their habits can be tracked on the basis of their pattern of consumption.

There is therefore a need for a method enabling consumers' private lives to be protected, at least partially, whilst guaranteeing satisfactory management of local energy generation.

### SUMMARY

An aspect of the invention proposes a solution to the problem described above, through the use of two methods allowing communication between the management systems and the controller through use of a participation profile which guarantees that a minimum of information is provided for satisfactory energy management.

To accomplish this, a first aspect of the invention concerns a method for transmitting a participation profile for a given period, known as the generation period, by an energy management system to a controller, where the period is divided into a first plurality of time periods, where the participation profile includes information concerning changes of consumption of the management system for each time period of the first plurality of time periods, and where the method includes:
a step of reception, by the management system, of a proposed penalty profile issued by the controller, where the generation period is divided into a second plurality of time periods, and where the penalty profile includes a penalty coefficient associated with the energy consumption for each time period of the second plurality of time periods;
a step of optimisation, by the management system, of energy consumption, depending on the proposed penalty profile;
a step of determination, by the management system, of a participation profile depending on the result of the optimisation step:
a step of transmission, by the management system, of the participation profile to the controller.

The management system thus transmits only the information which is strictly required by the controller, in order for the latter to be able to distribute the energy consumption. The private lives of the persons are thus protected, whilst distribution is implemented satisfactorily.

The method according to a first aspect of the invention may also have one or more of the characteristics below, considered individually, or in all technically possible combinations.

In an implementation the participation profile associates with each time period of the first plurality of time periods one of the following three indications: the consumed energy will increase; the consumed energy will remain stable; the consumed energy will be reduced.

A second aspect of the invention concerns a method of controlling a plurality of management systems, where the method includes:
an initialisation phase including:
   a step of reception, by the controller, of the energy generation forecasts of a local energy source, and of a penalty profile of an electrical network;
   a step of determination, by the controller, of the number of management systems participating in the sharing of the energy of the local energy source, and of random selection of the corresponding management systems;
a phase of obtaining a consumption profile including:
   a step of transmission, by the controller, of a plurality of penalty profiles to the plurality of management systems, where each management system receives a penalty profile, where the generation period is divided into a second plurality of time periods, and where the penalty profile includes a penalty coefficient associated with the energy consumption for each time period of the second plurality of time periods;
   a step of reception, by the controller, of a plurality of participation profiles, where each participation profile is associated with a management system, where the production period is divided into a first plurality of time periods, and where the participation profile includes information on the changes of consumption of the management system for each time period of the first plurality of time periods;
   a step of determination, by the controller, from the plurality of participation profiles, of a projected consumption profile;
   a step of comparison, by the controller, of the projected consumption profile with a target consumption profile;
      where the phase of obtaining a consumption profile is repeated until one of the following conditions is met:
the projected consumption profile is identical to the target consumption profile;
the plurality of participation profiles is identical during two consecutive iterations of the phase of obtaining a consumption profile.

The controller can thus implement the distribution of energy consumption between a plurality of management systems even if the latter give only incomplete information concerning their energy consumption, thereby protecting the private lives of the users of the system.

The method according to a second aspect of the invention may also have one or more of the characteristics below, considered individually, or in all technically possible combinations.

In an implementation the target consumption profile is established according to the energy generation forecasts of the local source.

The controller thus ensures that the energy consumption is distributed so as to consume all the energy generated by the local energy source.

In an implementation the participation profile associates with each time period of the first plurality of time periods one of the following three indications: the consumed energy will increase; the consumed energy will remain stable; the consumed energy will be reduced.

The data provided by the systems for managing the plurality of management systems is thus restricted to the strict minimum.

A third aspect of the invention concerns a system of managing the energy of an electrical installation including a system (e.g. one or more electronic circuits) to implement a method according to a first aspect of the invention.

A fourth aspect of the invention concerns a controller controlling a local electrical grid including a system (e.g. one or more electronic circuits) to implement a method according to a second aspect of the invention.

A fifth aspect of the invention concerns a computer program including instructions which, when the program is executed by a management system, respectively a controller, cause it to implement the method according to a first aspect of the invention, respectively the method according to a second aspect of the invention.

A sixth aspect of the invention relates to a non-transitory computer-readable data medium on which the computer program product according to a fifth aspect of the invention is recorded.

### BRIEF DESCRIPTION OF THE FIGURES

Other characteristics and benefits of the invention will become clear from the description which is given of it below, by way of example and non-restrictively, with reference to the appended figures, in which:

FIG. 1, which shows a diagrammatic representation of a pool able to be managed by a method according to a first and second aspect of the invention;

FIG. 2, which represents a flow chart of a method according to a first aspect of the invention;

FIG. 3, which represents a participation profile and a target profile reconstituted from the participation profile;

FIG. 4, which represents a flow chart of a method according to a second aspect of the invention;

For greater clarity, identical or similar elements are identified by identical reference signs in all the figures.

### DETAILED DESCRIPTION

FIG. 2 represents a first implementation of a method 100 for transmitting a participation profile for a given period known as the generation period, by an energy management system SY to a controller CO according to a first aspect of the invention. For example, the generation period may have a duration of 24 h. In what follows a management system SY must be understood as a device controlling the electrical energy supply of an electrical installation (for example a home, a collective building, a factory, etc.). The energy consumption of a management system SY is therefore equal to the energy consumption of the electrical installation. In an implementation, the management system SY include one or more electronic circuits for implementing the functions of the management system.

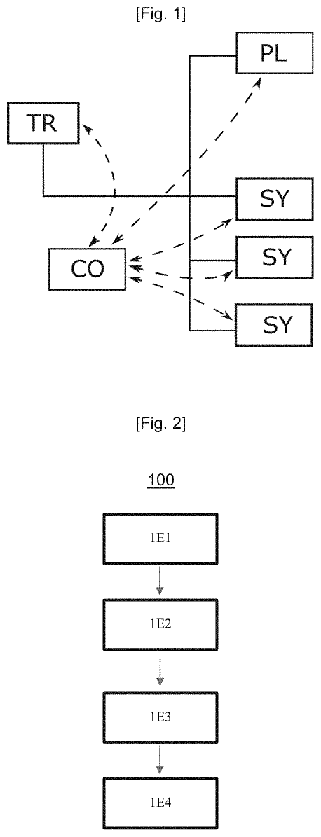

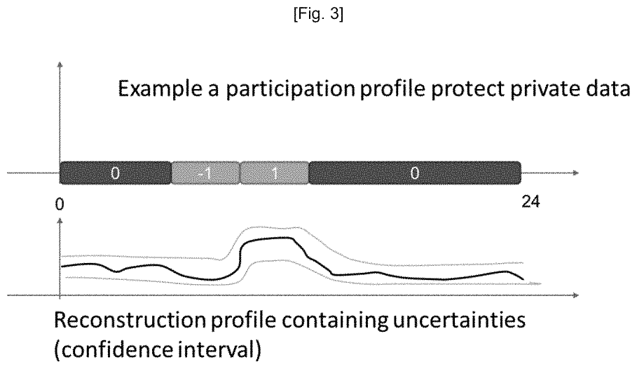

The participation profile transmitted to controller CO by management system SY includes information on the changes of consumption of management system SY over time during the generation period. More specifically, the generation period is divided into a plurality of time periods, where the time periods of the first plurality of time periods are, for example, of identical duration. In an implementation the duration of a time period is greater than or equal to one minute. In an implementation the duration of a time period is greater than or equal to one hour. In addition, the participation profile includes information on changes of consumption of management system SY for each time period of the plurality of time periods, where the changes associated with a time period are relative to the consumption during the previous time period. In an implementation the participation profile associates with each time period of the first plurality of time periods one of the following three indications: the consumed energy will increase; the consumed energy will remain stable; and the consumed energy will be reduced. An example of such a profile is represented in FIG. 3 for a generation period of a duration of 24 h, in which the profile can include three different items of information encoded by three figures: 0, 1 or −1 (other figures could of course be used). Figure 0 means that management system SY anticipates that its consumption will not change over the time period concerned. Figure −1 means that management system SY anticipates that its consumption over the time period concerned will be reduced relative to consumption during the previous time period. Finally, Figure 1 means that management system SY anticipates that its consumption over the time period concerned will increase relative to consumption during the previous time period. In the example of FIG. 3 consumption will firstly remain unchanged (in this case, since it concerns the first time period of the generation period, the variation is relative to the last period of the previous generation period), then be reduced, then increase, and finally become stabilised. From this information the controller can reconstitute a projected consumption profile (the black curve), where this reconstitution is associated with a margin of error (the two grey curves either side of the black curve). The way in which the projected consumption profile is reconstructed will be described in detail below. It is of course possible to envisage other ways of providing a participation profile, for example by indicating ranges of increase. In such a profile management system SY stipulates, for example, the way its consumption has changed in percentage terms, plus or minus a factor of uncertainty for each time period. Other solutions are of course conceivable. The aim of the participation profile is not therefore to provide the precise consumption envisaged by management system SY, but only changes in it. This procures a definite benefit in terms of data confidentiality: controller CO does not have access to the energy consumption of management system SY.

Method 100 according to a first aspect of the invention includes a step 1E1 of reception, by management system SY, of a proposed penalty profile issued by controller CO, where the penalty profile includes a penalty coefficient associated with the energy consumption as a function of time. Calculation of the penalty profiled by controller CO will be described in detail in what follows, during the description of a control method 200 according to a second aspect of the invention. In order to understand method 100 according to a first aspect of the invention one should know simply that the penalty profile is the way a penalty changes over time. In other words, the generation period is divided into a second plurality of time periods, where the time periods of the second plurality of time periods are preferably of identical durations, and the penalty profile associates a penalty coefficient for energy consumption over the time period with each time period of the second plurality of time periods. One possibility is to choose a penalty coefficient which depends on the price of energy and/or the CO₂ emission rate associated with the energy for the time period in question. More generally, the penalty coefficient may be representative of the abundance (or scarcity) of the energy, or alternatively its more or less polluting character over the time period in question, and/or of energy demand over the time period in question. It will be understood therefore that the penalty coefficient is above all a tool enabling energy consumption to be regulated over time. In an implementation the division of the penalty profile and of the participation profile into time periods is identical.

Method 100 then includes a step 1E2 of optimisation, by management system SY, of energy consumption, depending on the proposed penalty profile. In other words, management system SY will distribute its consumption over the course of the generation period concerned so as to minimise the consumption penalty over the period. This optimisation can consist in particular in heating the water in a hot water tank when the penalty is lowest. Similarly, when an energy storage solution is available it will be charged when the penalty is low, and discharged when the penalty is high. The methods for optimising energy consumption are known to the person skilled in the art, and will not therefore be described in greater detail here. The reader can, for example, make reference to the document “An optimal approach for electrical management problem in dwellings”, D L Ha, H Joumaa, S Ploix, M Jacomino—Energy and Buildings, 2012.

Method 100 then includes a step 1E3 of determination, by management system SY, of a participation profile depending on the result of optimisation step 1E2. Indeed, after optimisation has been accomplished management system SY knows what its consumption over time will be, and can therefore also determine how it will change from one time period to the next (i.e. determine the participation profile).

Finally, method 100 includes a step 1E4 of transmission, by management system SY, of the participation profile to controller CO. As previously mentioned, the transmission concerns only changes of consumption between two time periods, and does not give any information concerning the actual consumption of management system SY. In other words, a method 100 according to a first aspect of the invention enables controller CO to receive the information strictly required to calculate an energy distribution. This calculation will now be described.

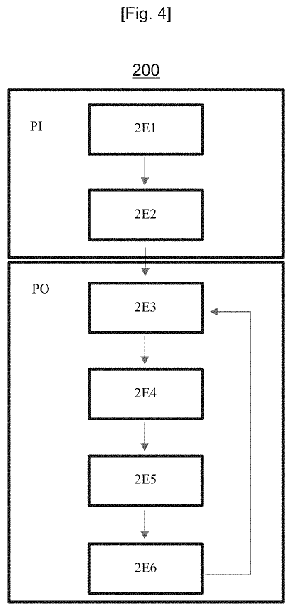

Method 200 according to a second aspect of the invention illustrated in FIG. 4 concerns a method of control by a controller CO of a plurality of management systems SY. A management system SY may, for example, be installed in each home in a district, and controller CO is then responsible for distribution of consumption within the district, where the district is at least partly supplied by a local energy source. The local energy source can, for example, come from a photovoltaic power station PL or wind power station PL. In an alternative or additional manner, the local generation means may include solar panels distributed over a plurality of buildings. The district may also be connected to the electrical network through a transformer TR, so as to meet the energy requirements when the latter cannot be entirely satisfied from local generation.

Method 200 according to a second aspect of the invention is divided into two phases: a phase PI of initialisation and a phase PO of obtaining a consumption profile.

Initialisation phase PI includes a step 2E1 of reception of the energy generation forecasts from at least one local source, and of a penalty profile from an electrical network, for example the national electricity grid. As with the penalty profile generated by controller CO, the penalty profile characterises changes in the penalty coefficient over time for the generation period in question. The energy generation forecast of local source PL can be determined from meteorological data, in particular the insolation and/or the force and direction of the wind. The penalty profile concerning the electrical network can, for example, be supplied by the operator or operators of the network.

Initialisation phase PI then includes a step 2E2 of determination of the number of management systems SY participating in the sharing of locally generated energy PL and of random selection of corresponding management systems SY. For example, if the required number of participants is three, then controller CO will select at random three management systems SY which will participate in consumption of local generated energy PL. The random character of the selection enables the confidentiality of the consumption of each management system SY to be improved, since different management systems SY are chosen each time a selection is made (except in rare cases, in which random selection leads to selection of the same systems SY over two consecutive generation periods). This therefore supposes that the consumption of these three management systems SY is sufficient to absorb all the energy supplied by local generation means PL. This also supposes that the average consumption of management systems SY of the plurality of management systems SY is known, and the determination of the number of management systems SY participating in sharing requires information on the probable consumption of systems SY. This average consumption will be able, for example, to be determined from the history of the consumption. Indeed, as the generation periods succeed one another controller CO will be able to constitute a history enabling the average consumption of each management system SY to be deduced. If such a history does not exist it is also possible to estimate this profile from data relating to each management system SY, such as the surface supplied by the system SY, the number of occupants associated with the system SY, the subscription used by the system SY (which stipulates the maximum energy per time unit which the system can consume), etc.

The aim of initial phase PI is therefore to know the number of participants involved in sharing local generation PL, and to select at random management system or systems SY which will participate in it. When this information is known it is possible to obtain a consumption profile, i.e. the energy consumption of all management systems SY of the plurality of management systems for the generation period in question (including that which does not contribute to the sharing of energy generated locally).

To this end, phase PO of obtaining a consumption profile includes a step 2E3 of transmission of a plurality of penalty profiles to the plurality of management systems SY, where each management system SY receives a penalty profile, where the generation period is divided into a second plurality of time periods, and where the penalty profile includes a penalty coefficient associated with the energy consumption for each time period of the second plurality of time periods. The plurality of penalty profiles is generated so as to cause consumption in the plurality of management systems SY in accordance with a target consumption profile. This target consumption profile is such that all the locally generated energy is consumed. It is also intended to restrict consumption in the electricity grid when the penalty coefficient is high. In other words, the purpose of the target consumption is to make energy demand correspond with the periods during which the energy is available in the largest quantities. In an implementation the penalty coefficient associated with a given time period is dependent on the energy consumed over the period. For example, the penalty coefficient may be low if the quantity of energy consumed is below a threshold, and high if it is above the threshold.

As was seen in connection with method 100 according to a first aspect of the invention, each management system SY will receive a profile penalty and will determine, from this penalty profile, a participation profile, before transmitting it to controller CO, which will then receive these and analyse them.

To do so, phase PO of obtaining a consumption profile includes a step 2E4 of reception of a plurality of participation profiles, where each participation profile is associated with a management system SY, where the generation period is divided into a first plurality of time periods, and where the participation profile includes information on changes of consumption of management system SY for each time period of the first plurality of time periods. It will be noted that the first plurality of time periods can be different for each management system SY.

It then includes a step 2E5 of determination, from the plurality of participation profiles, of a projected consumption profile. In order to establish this projected consumption profile controller CO can analyse the consumption profiles obtained in the previous generation periods. As previously mentioned, as the generation periods succeed one another controller CO will be able to constitute a history allowing, from a plurality of participation profiles, a projected consumption profile to be determined. If such a history does not exist it is also possible to estimate this profile from information relating to each management system SY, such as the surface supplied by the system, the number of occupants associated with system SY, the subscription used by system SY (which stipulates the maximum energy per time unit which the system can consume), etc.

When the projected consumption profile has been determined it is desirable to ensure that it meets the desired goal, or at least comes close to it. To this end, phase PO of obtaining a consumption profile then includes a step 2E6 of comparison of the projected consumption profile with a target consumption profile. The target consumption profile may be established according to the energy generation forecasts of local source PL. It is thus possible to ensure, through the target profile, that preference is given to the generation of local source PL as energy is consumed.

Two satisfactory situations can be identified. In a first situation the projected consumption profile is identical to the target consumption profile. The term “identical” is understood to mean that

$${\sum }_{k = 1}^{K} \vert {P}_{prev} ( k ) - {P}_{cible} ( k ) \vert \leq ɛ ,$$

where Pₚᵣₑᵥ(k) is the projected consumption profile over the time period k and P_{cible}(k) is the target consumption profile over the time period k, where K is the total number of time periods over the generation period, and ε a predefined threshold.

This is dearly the most desirable situation, since it enables it to be ascertained that the goals have been attained, in particular in terms of consumption of locally generated energy. It may be the case, however, that the target consumption profile is not attained. In this case, a second possible situation is that in which the plurality of participation profiles is identical during two consecutive iterations of the phase of obtaining a consumption profile; which supposes, of course, that there have been two iterations of phase PO of obtaining a consumption profile. In other words, when it does not seem possible to attain the target consumption profile the projected profile corresponding to the best compromise is chosen.

In a method 200 according to a second aspect of the invention, phase

PO of obtaining a consumption profile is therefore repeated until one of these two situations (or conditions) is met. To determine the penalty profile transmitted to each management system during each iteration of acquisition phase PO, the method will, for example, make use of an ADMM algorithm (for “alternating direction method of multipliers”). The details of this algorithm are given, in particular, in “An ADMM approach to dynamic sharing problems”, Cao et al, 52nd Annual Conference on Information Sciences and Systems (CISS), 2018. This is of course only one example, and other optimisation methods can be used.

In an implementation of a method 200 according to a second aspect of the invention, the participation profile associates one of the following three indications with each time period: the consumed energy will increase; the consumed energy will remain stable; the consumed energy will be reduced. The information provided by each management system SY to controller CO is thus minimal, although it enables it to determine a projected consumption profile.

In an implementation the generation period has a duration of 24 h.

A third aspect of the invention concerns a management system SY including the system to implement a method 100 according to a first aspect of the invention. In an implementation, management system SY includes a calculation device (for example a processor including one or more electronic circuits) associated with a non-transitory memory (for example a RAM memory and/or a hard disk). The memory is, in particular, configured to store the instructions required to implement a method 100 according to a first aspect of the invention, together with the data required for this implementation. In an implementation management system SY includes a communication device (for example a GSM, WiFi, Bluetooth communication device, or alternatively one using the PLC technique), so as to be able to receive data from a controller CO or to transmit data to the controller CO. The communication device includes one or more electronic circuits for receiving and/or transmitting data.

A fourth aspect of the invention concerns a controller CO including a system to implement a method 200 according to a second aspect of the invention. In an implementation, controller CO includes a calculation device (for example a processor including one or more electronic circuits) associated with a non-transitory memory (for example a RAM memory and/or a hard disk). The memory is, in particular, configured to store the instructions required to implement a method 200 according to a second aspect of the invention, together with the data required for this implementation. In an implementation controller CO includes a communication device (for example a GSM, WiFi, Bluetooth communication device, or alternatively one using the PLC technique), so as to be able to receive data from one or more controller management systems, or to transmit data to the management system or systems. The communication device includes one or more electronic circuits for receiving and/or transmitting data. It also includes a communication device so as to be able to receive information from the local generation source (for example, to receive the generation forecasts), or from the electrical grid (for example the penalty profile associated with the energy in the network).

It will be appreciated that the invention is not limited to the implementations described with reference to the figures, and variants could be envisaged without going beyond the scope of the invention.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium (e.g. a memory) is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “programmed processor” encompasses all kinds of apparatus, devices, and machines for processing data, including by way of example a programmable processor, digital signal processor (DSP), a computer, a system on a chip, or multiple ones, or combinations, of the foregoing. The apparatus can include special purpose logic circuitry, e.g., an FPGA (field programmable gate array) or an ASIC (application-specific integrated circuit).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The present invention has been described and illustrated in the present detailed description and in the figures of the appended drawings, in possible embodiments. The present invention is not however limited to the embodiments described. Other alternatives and embodiments may be deduced and implemented by those skilled in the art on reading the present description and the appended drawings.

In the claims, the term “includes” or “comprises” does not exclude other elements or other steps. A single processor or several other units may be used to implement the invention. The different characteristics described and/or claimed may be beneficially combined. Their presence in the description or in the different dependent claims do not exclude this possibility. The reference signs cannot be understood as limiting the scope of the invention.

1. A method for transmitting a participation profile for a generation period, by an energy management system to a controller, where the generation period is divided into a first plurality of time periods, where the participation profile includes information concerning changes of consumption of the management system for each time period of the first plurality of time periods, the method comprising:
receiving, by the management system, a proposed penalty profile issued by the controller, where the generation period is divided into a second plurality of time periods, and where the penalty profile includes a penalty coefficient associated with the energy consumption for each time period of the second plurality of time periods:
optimizing, by the management system, an energy consumption of the system for the generation period in question, depending on the proposed penalty profile;
determining, by the management system, the participation profile depending on the result of the optimizing, and
transmitting, by the management system, the participation profile to the controller.

2. A method of control by a controller of a plurality of management systems, the method comprising:
an initialisation phase including:
receiving, by the controller, the energy generation forecasts of a local energy source, and of a penalty profile of an electrical network;
determining, by the controller, a number of management systems participating in the sharing of the energy of the local energy source, and of random selection of the corresponding management systems;
a phase of obtaining a consumption profile including:
transmitting, by the controller, a plurality of penalty profiles to the plurality of management systems, where each management system receives a penalty profile, where the generation period is divided into a second plurality of time periods, and where the penalty profile includes a penalty coefficient associated with the energy consumption for each time period of the second plurality of time periods;
receiving, by the controller, a plurality of participation profiles, where each participation profile is associated with a management system, where the production period is divided into a first plurality of time periods, and where the participation profile includes information on the changes of consumption of the management system for each time period of the first plurality of time periods;
determining, by the controller, from the plurality of participation profiles, of a projected consumption profile;
comparing, by the controller, the projected consumption profile with a target consumption profile;
where the phase of obtaining a consumption profile is repeated until one of the following conditions is met:
the projected consumption profile is identical to the target consumption profile;
the plurality of participation profiles is identical during two consecutive iterations of the phase of obtaining a consumption profile.

3. The method according to claim 2, wherein the target consumption profile is established according to the energy generation forecasts of local source.

4. The method according to claim 1, wherein the participation profile associates with each time period of the first plurality of time periods one of the following three indications:
the consumed energy will increase;
the consumed energy will remain stable;
the consumed energy will be reduced.

5. A system for managing the energy of an electrical installation including one or more electronic circuits to implement a method according to claim 1.

6. A controller for managing a local electrical grid including one or more electronic circuits to implement a method according to claim 2.

7. A non-transitory computer readable medium comprising instructions which, when executed by a controller, lead the controller to implement he method according to claim 1.
